(19) United States
(12) Patent Application Publication
(10) Pub. No.: US 2012/0075539 A1
(43) Pub. Date: Mar. 29, 2012

(54) PROJECTION DISPLAY DEVICE

(75) Inventors: Teppei KONISHI, Fukushima (JP); Atsushi Koyanagi, Fukushima (JP); Ayako Tanaka, Tokyo (JP); Hiroshi Kumai, Fukushima (JP); Yoshiharu Ooi, Tokyo (JP)

(73) Assignee: Asahi Glass Company, Limited, Chiyoda-ku (JP)

(21) Appl. No.: 13/310,835

(22) Filed: Dec. 5, 2011

Related U.S. Application Data
(63) Continuation of application No. PCT/JP10/59720, filed on Jun. 8, 2010.

(30) Foreign Application Priority Data
Jun. 12, 2009 (JP) 2009-141259
Nov. 10, 2009 (JP) 2009-257354
Mar. 18, 2010 (JP) 2010-062949

(51) Int. Cl. G02F 1/1335

(52) U.S. Cl. 349/5

(57) ABSTRACT

A projection display device is provided with: a light source portion including at least one light source that emits coherent light; an image light generation portion that generates image light by modulating the light emitted by the light source portion; a projection portion that projects the image light; a liquid crystal scattering element that is disposed on an optical path between the light source portion and the image light generation portion and temporally changes scattering state for passing light; a transparent electrode formed on each of opposing surfaces of a plurality of transparent substrates of the liquid crystal scattering element; and a liquid crystal layer that is sandwiched between the transparent electrodes and has liquid crystal of a smectic phase having spontaneous polarization in voltage applied state, and is characterized in that an AC voltage is applied to the liquid crystal layer through the transparent electrode.

### TECHNICAL FIELD

The present invention relates to a projection display device, and more particularly, relates to a projection display device using a light source having coherency.

### BACKGROUND ART

While an ultra high pressure mercury (UHP) lamp has conventionally been used as the light source of display devices that display a projection image on a screen such as a data projector or a rear projection television receiver, lasers have been proposed from the standpoint of light source life.

Moreover, a combined use type light source has also been proposed that uses a laser as the red light source and uses a UHP lamp for the blue and green wavelength ranges since the UHP lamp has, because of its characteristics, abroad spectrum in a wavelength band in the vicinity of 645 nm which is the wavelength of red.

However, projection display devices with a laser as the light source have a problem in that granular speckle noise attributed to the coherency of the laser light is caused in the projection image and this degrades the quality of the projection image.

Therefore, a projection display device with reduced speckle noise has a form in which a diffusing element is disposed on the optical path of the laser light serving as the light source and this diffusing element is rotated and vibrated at a speed higher than the speed that can be recognized by the human eye. By thus mechanically operating the diffusing element, the laser light having coherency is brought into a state where the phase is spatially shifted, thereby eliminating the speckle noise (e.g. Patent Document 1).

Moreover, as a device eliminating the speckle noise without the action of mechanically vibrating a diffusing element or the like, an image display device has been proposed in which a complex liquid crystal film is disposed on the optical path of the light emitted from a semiconductor laser diode and a voltage is applied to this complex liquid crystal film to thereby change the phase of the incident light (Patent Document 2). Likewise, as a device eliminating the speckle noise, an optical device has been proposed in which the refractive index of the ferroelectric substrate is temporally changed by applying a voltage to an electrooptic device where electrodes are formed in a ferroelectric substrate (crystal) such as lithium niobate where irregular polarization-reversed domains are formed (Patent Document 3).

### PRIOR ART DOCUMENTS

### Patent Documents

Patent Document 1: Japanese Unexamined Patent Application Publication No. H06-208089
Patent Document 2: Japanese Unexamined Patent Application Publication No. 2005-338520
Patent Document 3: WO 99/049354

### SUMMARY OF THE INVENTION

### Problems to be Solved by the Invention

However, with the structure like that of Patent Document 1, since a driver including a motor or a coil is required to rotate or vibrate the diffusing element, not only the device is increased in size but also there is a problem with reliability such that noise is caused by the mechanical vibrations.

Moreover, in Patent Document 2, since the phase of the transmitted light is modulated by the applied voltage by using the refractive index anisotropy of the liquid crystal used for the liquid crystal lens (complex liquid crystal film), for example, when the liquid crystal lens is formed of nematic liquid crystal, the amount of phase change (retardation value: the product of the “refractive index anisotropy” and the “thickness of the liquid crystal film”) must be increased so that the speckle noise can be sufficiently reduced. In that case, the thickness of the liquid crystal film must be increased in order to increase the phase amount, and the response speed decreases as the thickness of the liquid crystal film increases. In addition, there is a problem in that a high voltage must be applied in order to obtain a desired response speed.

In Patent Document 3, since the phase of the transmitted light is also modulated by the voltage applied to the ferroelectric substrate, to increase the amount of phase change, the thickness of the ferroelectric substrate must be increased similarly, and it is necessary to control an AC voltage superimposed with a DC voltage when applying the AC voltage to the domains irregularly formed in this ferroelectric substrate. Further, since inorganic crystal is used, there is a problem in that there is difficulty with production such as processing. Moreover, in addition thereto, unlike the function of modulating the phase of the transmitted light, as a structure scattering light, as a dynamic scattering mode (DSM), for example, by the liquid crystal making an irregular molecular motion by the ions (conductive material) in the nematic liquid crystal moving to cause a space-charge effect, the effect of scattering light can be expected. However, because of current effect driving, degradation occurs on the liquid crystal and the conductive material, so that there is a problem with the reliability as to long-term use.

The present invention is made to solve such problems of the conventional art, and an object thereof is to provide a highly reliable projection display device capable of stably reducing the spackle noise with a simple structure when a light source having coherency is used.

### Means for Solving the Problem

The present invention provides a projection display device provided with: a light source portion including at least one light source that emits coherent light; an image light generation portion that generates image light by modulating the light emitted by the light source portion; a projection portion that projects the image light; a liquid crystal scattering element that is disposed on an optical path between the light source portion and the image light generation portion and temporally changes scattering state for passing light; a transparent electrode formed on each of opposing surfaces of a plurality of transparent substrates of the liquid crystal scattering element; and a liquid crystal layer that is sandwiched between the transparent electrodes and has liquid crystal of a smectic phase having spontaneous polarization in voltage applied state, and characterized in that an AC voltage is applied to the liquid crystal layer through the transparent electrode.

Moreover, a condenser lens that condenses scattered light may be disposed on the optical path between the liquid crystal scattering element and the image light generation portion.

Moreover, alignment processing is not necessarily performed on an interface of the liquid crystal layer.

Moreover, the liquid crystal may be chiral smectic C phase liquid crystal.

Moreover, the liquid crystal may have a structure having a phase transition series of Iso-N(*)-SmC*.

Moreover, the liquid crystal scattering element may have a structure in which the liquid crystal layer is stacked more than one in number.

Moreover, a phase of an AC voltage applied to a first liquid crystal layer of the more than one liquid crystal layer and a phase of an AC voltage applied to a second liquid crystal layer of the more than one liquid crystal layer may be different from each other.

Moreover, the liquid crystal scattering element may have a structure having a prism array sheet.

Moreover, the liquid crystal scattering element may have a structure having a reflection layer that reflects incident light.

Moreover, a voltage where the scattering state occurs may be 3 to 100 Vrms.

Moreover, a frequency of the voltage where the scattering state occurs may be 70 to 1000 Hz.

Further, a light scattering element that scatters incident light and emits the light may be disposed on the optical path between the light source portion and the liquid crystal scattering element and on the optical path between the liquid crystal scattering element and the image light generation portion. Further, a light scattering element that scatters incident light and emits the light may be disposed on the optical path between the light source portion and the liquid crystal scattering element. Further, a light scattering element that scatters incident light and emits the light may be disposed on the optical path between the liquid crystal scattering element and the image light generation portion.

### Effects of the Invention

The present invention is capable of providing a projection display device having the effect of being able to reduce the speckle noise with ease and stability when a light source having coherency is used.

### BRIEF DESCRIPTION OF THE DRAWINGS

FIG. 1 is a conceptual structure view of a projection display device according to a first embodiment.

FIG. 2 is a schematic cross-sectional view of a liquid crystal scattering element.

FIG. 3 is a schematic cross-sectional view of a liquid crystal scattering element having another structure.

FIG. 4A is a schematic view showing a scattering angle of the liquid crystal scattering element.

FIG. 4B is a graph showing the full width at half maximum of the transmitted light.

FIG. 5 is a conceptual structure view of a projection display device according to a second embodiment.

FIG. 6 is a conceptual structure view of a projection display device according to a third embodiment.

FIG. 7 is a conceptual structure view of a projection display device according to a fourth embodiment.

FIG. 8 is a schematic cross-sectional view of a reflective liquid crystal scattering element.

FIG. 9 is actual measured values of the transmittance with respect to the voltage applied to the liquid crystal scattering element (Example 1).

### MODE FOR CARRYING OUT THE INVENTION

### First Embodiment

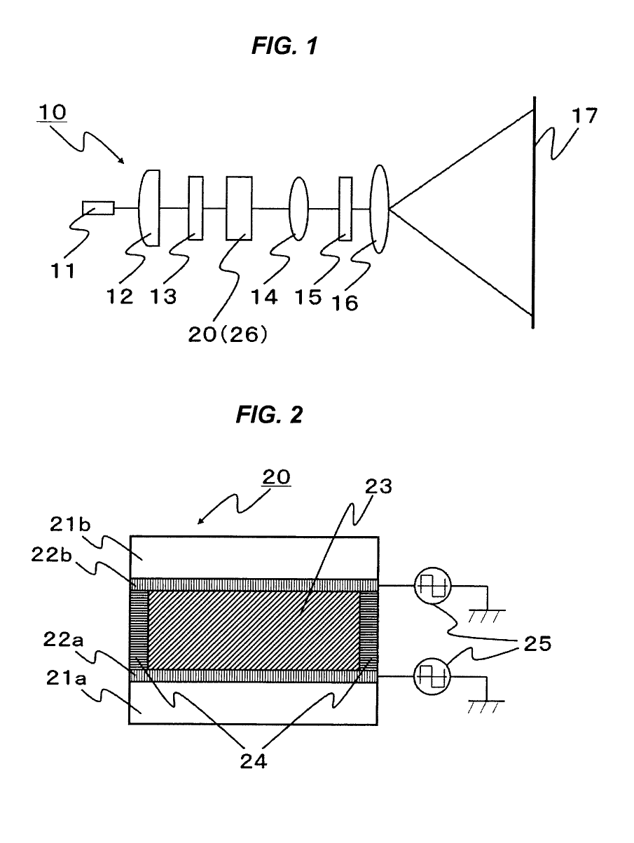

FIG. 1 is a schematic view showing an example of the structure of a projection display device 10 according to the present embodiment. The light emitted from at least one laser 11 such as a semiconductor laser or a solid-state laser as the light source that emits coherent light as light emitting means is focused in such a way as to become substantially parallel light by a collimator lens 12, and passes through a polarizer 13. As the laser 11, for example, the semiconductor laser emits linearly polarized light; however, there are cases where the polarization direction thereof varies or temporally fluctuates due to process variations or usage environment temperature changes. The polarizer 13 is for making the polarization state of this light constant. The light having passed through the polarizer 13 exits with the spatial light coherency being averaged by temporally changing the light scattering state by a liquid crystal scattering element 20 of the invention of the present application. The scattered light transmitted by the liquid crystal scattering element 20 is focused by a condenser lens 14 on a spatial light modulator 15 as image generating means. Moreover, the light emitted from the laser 11 may be light scattered by being guided by using a fiber or the like, and in this case, the projection display device 10 may have a structure not including the collimator lens 12 or the polarizer 13.

The light scattered by the liquid crystal scattering element 20 passes through the condenser lens 14, and then, is homogenized and radiated to the spatial light modulator 15. As the condenser lens 14, for example, a condenser lens with a large numerical aperture may be used so that light whose angle of scattering by the liquid crystal scattering element 20 is large can also be condensed. Specifically, the numerical aperture is preferably not less than 0.55, and the larger the numerical aperture is, the more efficiently light can be captured and the higher the utilization efficiency of the light can be made. As the spatial light modulator 15, while a transmissive liquid crystal panel is typically usable, a reflective liquid crystal panel or a digital micromirror device (DMD) may be used. The luminous flux thus incident on the spatial light modulator 15 is modulated according to the image signal, and projected onto a screen 17 or the like by a projector lens 16. For the light source, any of the following may be adopted: a structure in which only one laser light source is used; a structure in which a plurality of laser light sources that emit light beams of different wavelengths are disposed; and a structure in which a light source having no coherency and a laser light source are used in combination.

Next, the cross-sectional view of the concrete structure of the liquid crystal scattering element 20 of the invention of the present application will be described by using FIG. 2. In the liquid crystal scattering element 20, transparent electrodes 22a and 22b are provided on one surfaces of two flat transparent substrates 21a and 21b, respectively, the transparent electrode surfaces thereof are opposed so as to be disposed substantially parallel to each other, and the gap between the transparent substrates is filled with liquid crystal. Moreover, sealing is made by a sealing member 24 around the periphery of the transparent substrates. To apply an AC voltage to a liquid crystal layer 23 filled with liquid crystal, wirings to supply a voltage to the transparent electrodes 22a and 22b are laid, and connected to power sources 25. Moreover, on the transparent substrates 21a and 21b, either of a non-illustrated insulating film and alignment film or both of them may be provided with the purpose of preventing short circuit between the transparent electrodes.

The liquid crystal scattering element 20 of the present invention has the function of causing temporal speckle pattern changes to occur by temporally changing the light scattering state for the incident coherent light. The image projected thereby is observed in a state where speckle noise is reduced. This liquid crystal scattering element 20 is characterized by using a light scattering mode induced by the spontaneous polarization direction inverting at high speed by applying an AC voltage to smectic phase liquid crystal having spontaneous polarization.

While the liquid crystal scattering element 20 of the present invention uses the light scattering mode in which a voltage is applied to smectic phase liquid crystal having spontaneous polarization as described later, the present invention is not limited thereto as long as it is an element using a material having spontaneous polarization and capable of temporally changing the scattering state of the incident light by changes of the applied voltage. For example, it may be an element using a polymer/liquid crystal composite film or electric field response cholesteric phase liquid crystal as another material.

Moreover, in normal displays using liquid crystal phase modulation, an alignment film having undergone alignment processing such as rubbing processing is formed in order to regulate the alignment of the liquid crystal molecules; however, in the liquid crystal scattering element 20 according to the projection display device of the invention of the present application, it is unnecessary that the alignment state of the liquid crystal molecules be regulated. To change the scattering state of the incident light in order to reduce the speckle noise, since the alignment state of the liquid crystal is random both at the state of voltage application and in the initial state with no voltage application and the transmitted light is also in scattered state at the voltage non-applied state, a state where the interface of the liquid crystal layer 23 has undergone no alignment processing, that is, the alignment film is not necessarily formed. By this structure, the light transmitted by the liquid crystal scattering element 20 has its polarization partly eliminated or has its polarization completely eliminated, so that the polarization-eliminated light can be used in the projection display device.

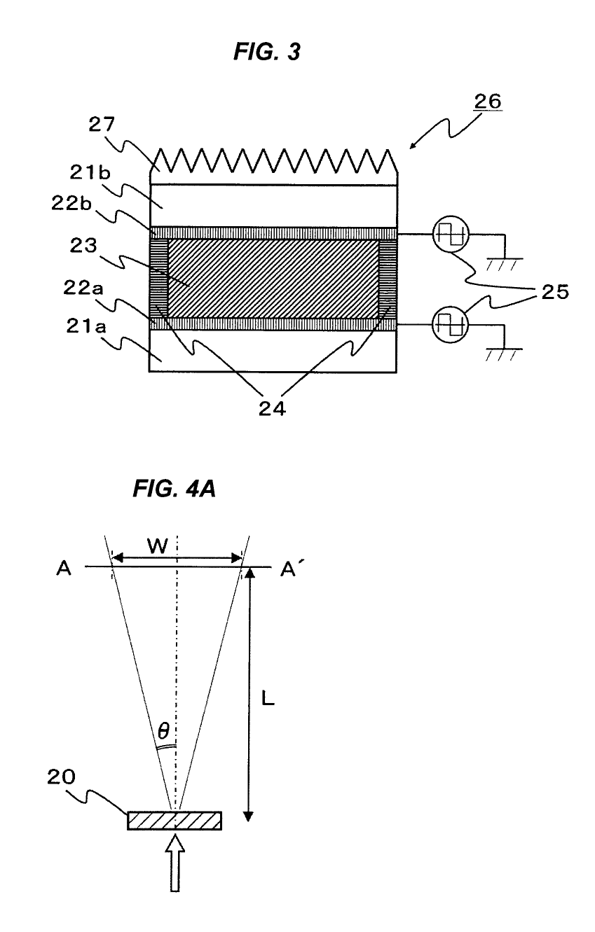

Moreover, as a structure different from the liquid crystal scattering element 20, a liquid crystal scattering element 26 shown in FIG. 3 may be used. The liquid crystal scattering element 26 has a structure in which a prism array sheet 27 is provided on the light exit side in addition to the structure of the liquid crystal scattering element 20. The prism array sheet 27 has the action of correcting the spread of the scattering angle described later. In FIG. 3, the prism array sheet 27 may be such that one sheet the longitudinal direction of the grooves of which is stretched in one direction is stacked on the transparent substrate 21b or may be such that two prism array sheets are disposed in such a way as to be superimposed one on another so that the longitudinal directions of the grooves thereof are orthogonal to each other. When two prism array sheets are used, an effect is obtained of being able to control the scattering angle of two-dimensionally exiting light.

Moreover, a non-illustrated plural light beam generation portion for converting the light incident on the liquid crystal scattering element 20 or 26 into a plurality of convergent light beams or parallel light beams the optical axes of which are substantially the same and that have a small numerical aperture NA may be provided on the optical path between the laser 11 and the liquid crystal scattering element 20 or 26. In this case, the liquid crystal layer 23 scatters these plural light beams generated by the plural light beam generation portion, thereby falsely generating a plurality of light emitting sources from the liquid crystal layer 23. As the condenser lens 14, a condenser lens may be used that efficiently captures the scattered light of each of the plurality of light emitting sources exiting from the liquid crystal layer 23 and has a plurality of lens structures converting these incident light beams into parallel light beams or convergent light beams. In this case, for example, the condenser lens 14 is preferably a unified array type condenser lens, and is defined as an exit side condenser lens array here. The structure and focal length of each lens included in the exit side condenser lens array, the distances thereof from the liquid crystal layer 23, and the like are designed as appropriate so that desired functions can be realized.

Moreover, the plural light beam generation portion that converts the light incident on the liquid crystal scattering element 20 or 26 into a plurality of light beams may be, for example, a unified array type condenser lens, and is defined as an incident side condenser lens array here. The incident side condenser lens array may be, for example, such that rectangular condenser lenses the ratio between the length and width of which is 9:16 are arranged in an array of 16 by 9 and the outer shape of the flat surface substantially orthogonal to the optical axis is square, and hereinafter, a case where this structure is provided will be described.

The light having exited from the laser 11 becomes substantially parallel light, and then, is incident on the liquid crystal layer 23 disposed in the vicinity of the focal position where it is focused by the plural light beam generation portion (incident side condenser lens array). Here, as the lenses included in the incident side condenser lens array, lenses with a numerical aperture NAᵢₙ of not more than 0.1 are used that generate convergent light with a comparatively large focal length. At this time, since 16-by-9 false light emitting sources are generated in the liquid crystal layer 23, the exit side condenser lens array corresponding one to one with such false light emitting sources is provided with a structure in which 16 by 9 rectangular condenser lenses the ratio between the length and width of which is 9:16 are arranged.

Here, when the incident side condenser lens array and the liquid crystal scattering element 20 or 26 are disposed through air, the numerical aperture NAₒᵤₜ of each condenser lens of the exit side condenser lens array is related to the half angle θ of the light capture angle by NAₒᵤₜ=sin θ. Therefore, the focal length of the exit side condenser lens array is set so that a relationship of NAₒᵤₜ>NAᵢₙ is possessed and that NAₒᵤₜ is such that the light scattered by the liquid crystal layer 23 is efficiently captured. Specifically, NAₒᵤₜ=0.26 to 0.64 corresponding to θ=15° (capture angle 30°) to 40° (capture angle 80°) is preferable. Even when the incident side condenser lens array and the liquid crystal scattering element 20 or 26 are disposed through a transparent medium such as an adhesive agent with a refractive index n>1, NAₒᵤₜ is set so that the exit side condenser lens array has a desired focal length.

Further, a single condenser lens that covers the entire luminous flux may be disposed on the light exit side of the exit side condenser lens array. In this case, light can be efficiently focused on the spatial light modulator 15 by making the principal rays of the condenser lenses of the exit side condenser lens array gather on the spatial light modulator 15. Moreover, by using a so-called fly eye lens including a pair of convex lens arrays described later as the exit side condenser lens array, the spatial light amount distribution of the exit light of each exit side condenser lens array is averaged, so that a projection image is obtained in which the light amount distribution of the light radiated to the spatial light modulator 15 is uniformized.

Moreover, while the liquid crystal layer 23 is formed of one layer in the liquid crystal scattering elements 20 and 26, the present invention is not limited thereto; the structure may be such that two or more liquid crystal layers are provided and a voltage can be applied to each liquid crystal layer. In this case, the scattering state of the incident light can be further increased by the plurality of liquid crystal layers, so that the effect of significantly reducing the speckle noise can be obtained. Further, when a plurality of liquid crystal layers are stacked, the magnitude of the voltage applied to each liquid crystal layer and the phase of the AC voltage can be arbitrarily set. For example, by the phase of the applied AC voltage being different among the liquid crystal layers, the scattering state of the incident light can be changed more largely with respect to time. Moreover, when a plurality of liquid crystal layers are stacked to form the liquid crystal scattering element, the structure of the liquid crystal scattering element 20 may be stacked more than one in number, or a structure including both the liquid crystal scattering element 20 and the liquid crystal scattering element 26 may be adopted.

Next, the material and mode that form the liquid crystal layer 23 will be concretely described. An example of the material that develops the present light scattering mode is, as a ferroelectric liquid crystal composition, chiral smectic (SmC*) phase liquid crystal, and this chiral SmC* phase liquid crystal has a helical pitch structure. And heretofore, as modes in which this chiral SmC* phase liquid crystal is enclosed between opposed substrates with an alignment film, the following two modes will be shown as examples: One is a surface stabilized ferroelectric liquid crystal (SSFLC) mode in which liquid crystal is enclosed in a space of an interval narrower than this helical pitch to thereby develop ferroelectricity at the voltage non-applied state (e.g. N. A. Clark, S. T. Lagerwall: Appl. Phys. Lett. 36,899 [1980]). The other is a DHFLC (deformed helix ferroelectric liquid crystal) mode in which liquid crystal is enclosed in a space of an interval (thickness) sufficiently wider than this helical pitch to thereby align it in such a way that the helical structure of the chiral SmC* phase liquid crystal remains.

In the DHFLC mode, since the spontaneous polarization direction rotates along the helical period, canceling out occurs. Therefore, in the initial state (at the voltage non-applied state), ferroelectricity is apparently canceled. On the other hand, it is a mode in which at the state of voltage application, continuous distortion of the helical structure is caused and spontaneous polarization develops (e.g. L. A. Beresnev, et al.: Liq. Cryst. 5, (4) 1171 [1989]). The liquid crystal layer 23 of the liquid crystal scattering element 20 of the invention of the present application is a space of an interval (thickness) sufficiently wider than the helical pitch of the chiral SmC* phase liquid crystal and has a structure such that the helical structure remains.

Moreover, as modes using characteristics of spontaneous polarization like the DHFLC mode, twisted FLC (e.g. V. Pertuis and J. S. Patel: Ferroelectrics, 149,193[1993]) and a τ-Vmin mode (e.g. J. R. Hughes, et. al: Liq. Cryst. 13,597[1993]) may be used.

Moreover, anti-ferroelectric liquid crystal may be used that is formed by applying some alignment to chiral smectic C_{A}(SmC_{A}*) phase liquid crystal by a substrate with an alignment film having undergone alignment processing. This case is a mode in which although ferroelectricity is also apparently canceled at the voltage non-applied state since the spontaneous polarization direction is random in the layer, a phase transition to the ferroelectric phase occurs with the voltage application and spontaneous polarization develops. Moreover, an electroclinic mode using chiral smectic A (SmA*) phase liquid crystal may be used.

Moreover, in addition to chiral smectic C phase liquid crystal, as hexatic phase liquid crystal having an inclination from the normal line of the layer as the phase structure, SmI phase liquid crystal and SmF phase liquid crystal are present. Further, as a phase in which SmI phase liquid crystal and SmF liquid crystal have three-dimensional order, crystal J, G, K, H phase liquid crystal is present; these liquid crystal phases including SmI phase liquid crystal and SmF phase liquid crystal are known to display ferroelectricity by the introduction of an asymmetric point, and may be used similarly.

While a liquid crystal composition having a smectic phase having spontaneous polarization is used for the liquid crystal layer 23 as described above, the liquid crystal composition does not necessarily display ferroelectricity at the voltage non-applied state, and is included in this category if it is provided with spontaneous polarization by the application of a desired voltage. Moreover, polymerized one or crystal by polymeric stabilization or the like may be used similarly. In addition thereto, side chain type polymer liquid crystal displaying ferroelectricity may be used similarly. In this case, polymeric stabilization and high molecular mass which bring stabilization of the liquid crystal phase have the effect of the operating temperature range being wide and stabilized.

While neither the upper limit nor the lower limit of the value of the spontaneous polarization (Ps) of the smectic phase liquid crystal composition used for the liquid crystal layer 23 is specifically limited, since a composition having excellent response to an external electric field is preferable in order to scatter the incident coherent light, a composition the absolute value of the spontaneous polarization of which is high is typically preferred. Moreover, since the effect of a composition with higher spontaneous polarization being able to reduce the driving voltage more is also produced, the absolute value of the spontaneous polarization is, preferably, not less than 10 nC/cm², more preferably, not less than 20 nC/cm², and yet more preferably, not less than 40 nC/cm² at normal temperature (25° C.).

Next, the temperature characteristics of the spontaneous polarization of the smectic phase liquid crystal composition used for the liquid crystal layer 23 will be described. Generally, the ferroelectric liquid crystal composition obtained by the development of the chiral smectic C phase is an indirect ferroelectric substance that occurs by an inclination of the rod-like liquid crystal molecules from the direction of the liquid crystal layer, and the value of the spontaneous polarization depends on molecular polarization and this inclination angle. In many cases, liquid crystal compositions exhibiting the smectic C phase make a transition to the smectic A phase on the higher temperature side of the smectic C phase temperature region, and since the phase transition at this time is a second-order phase transition and the inclination angle with reference to the direction of the thickness of the liquid crystal gradually approaches 0° as the temperature increases, the spontaneous polarization also approaches 0 as the temperature increases.

On the other hand, when a transition is made from the smectic C phase to the (chiral) nematic phase, since the phase transition at this time is a first-order phase transition and the inclination angle drastically changes from a finite value to 0 at the transition point, the spontaneous polarization maintains a constant value that is not 0, also in the vicinity of the phase transition temperature. That is, of the chiral smectic phase liquid crystal compositions, compared with the liquid crystal compositions having a phase transition series of Iso-N(*)-SmA-SmC*, in the liquid crystal compositions having Iso-N(*)-SmC* not having the smectic A phase, the spontaneous polarization does not become the vicinity of 0 even in the vicinity of the upper limit of the temperature at which the smectic C phase develops, so that the light scattering mode induced by the spontaneous polarization direction inverting at high speed by applying an AC voltage can be efficiently obtained.

Here, the liquid crystal compositions having Iso-N(*)-SmA-SmC* is excellent in orientation for alignment films compared with the liquid crystal compositions having Iso-N(*)-SmC*. Moreover, while any of these liquid crystal compositions may be used when the liquid crystal element of the invention of the present application has a structure including no alignment film, for the above-mentioned reason, the liquid crystal compositions having Iso-N(*)-SmC* are preferable since they have spontaneous polarization that is not 0, even at high temperatures.

Next, the thickness (cell gap) of the liquid crystal layer 23 is preferably not less than 5 μm as an interval where the helical structure remains. Moreover, for speckle noise reduction, the higher the degree of scattering with respect to the incident coherent light, the more effective, and for this reason, it is generally preferable that the cell gap of the liquid crystal layer 23 be large; however, since the applied voltage must be increased because of the thickness increase, the cell gap is preferably not more than 200 μm. Further, in order that the helical structure remains with reliability and to obtain the effect of being able to suppress the applied voltage, this interval (thickness) is more preferably not less than 20 μm and not more than 100 μm.

It is preferable that the frequency of the AC voltage applied to the liquid crystal layer 23 be used at 5 to 1000 Hz. Moreover, in order that sufficient temporal scattering state can be obtained for the incident light and to reduce the applied voltage necessary for speckle noise reduction because of low-frequency driving, it is more preferable to perform driving at approximately 70 to 200 Hz. Moreover, when driving is performed at a frequency in this range, the necessary voltage is 3 to 100 Vrms, preferably, 10 to 60 Vrms, and more preferably, approximately 2 to 40 Vrms.

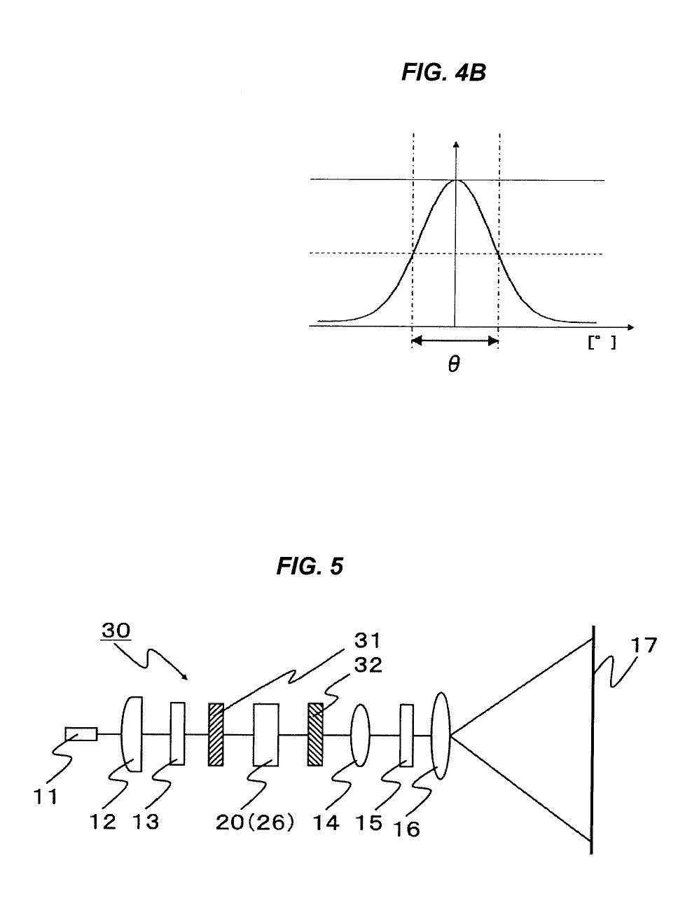

Moreover, to reduce the speckle noise, a constant scattering angle is made to be obtained by the liquid crystal layer 23. The scattering angle is defined as an angle that satisfies the full width at half maximum (FWHM) with respect to the intensity distribution of the light transmitted by the liquid crystal layer 23. The scattering angle will be concretely described by using FIGS. 4A and 4B. FIG. 4A is a schematic view showing the light incident on the liquid crystal scattering element 20 and the condition of the scattered and transmitted light, and shows a cross section A-A′ orthogonal to the rectilinear direction of the incident light at a distance L sufficiently away from the liquid crystal scattering element 20. The distance L [mm] is a distance of an extent such that the thickness of the liquid crystal scattering element 20 can be ignored. FIG. 4B is a view showing the optical axis, and the light intensity distribution when the angle that the light beam traveling toward the cross section A-A′ forms with the optical axis with the base point being set at the point where the liquid crystal scattering element 20 and the optical axis intersect with each other is the horizontal axis. Here, when the angle satisfying the full width at half maximum of the light intensity is a diffusion angle θ [°] and the diffusion region of the cross section A-A′ where the diffusion angle θ is attained is W [mm], the scattering angle θ and the distance L can be given by tan θ=W/2L.

If the value of the diffusion angle θ is high, the intensity of the rectilinearly transmitted light is low; on the other hand, if the value is low, the light cannot be sufficiently scattered, so that the speckle noise cannot be sufficiently reduced. Therefore, the scattering angle θ is, preferably, in a range of 10° to 70°, more preferably, in a range of 20° to 60°, and yet more preferably, in a range of 30° to 50°. Moreover, in the liquid crystal scattering element 20, the rectilinear transmittance represented by the ratio of the amount of rectilinearly transmitted light to the amount of rectilinearly incident light is, preferably, not more than 70%, more preferably, not more than 20%, and yet more preferably, not more than 10%. Moreover, it is most preferably not more than 5%. If the light is scattered at a constant scattering angle, the lower limit of the rectilinear transmittance may be 0%.

While as the transparent substrates 21a and 21b, for example, acrylic resin, epoxy resin, vinyl chloride resin or polycarbonate may be used, a glass substrate is suitable from the viewpoint of durability and the like. While as the transparent electrodes 22a and 22b, a metal film formed of Au, Al or the like may be used, the use of a film of ITO, SnO₃ or the like which has excellent light transmittance and is excellent in mechanical durability compared with the metal film is suitable.

The sealing member 24 is for preventing the ferroelectric liquid crystal in the liquid crystal layer 23 from leaking from between the transparent substrates 21a and 21b, and is provided around an optically effective region to be ensured. While as the material of the sealing member 24, an adhesive agent of resin such as epoxy or acryl is preferable from the viewpoint of handling, a material hardened by heating or UV light irradiation may be used. Moreover, several percent of spacers such as glass fibers may be mixed to obtain a desired cell interval.

The provision of an antireflection film on the parts, not in contact with the liquid crystal layer 23, of the surfaces of the transparent substrates 21a and 21b is suitable since it improves the utilization efficiency of the light. While a dielectric multilayer film, a thin film on the order of the wavelength, or the like may be used as such an antireflection film, other films may be used. While these films may be formed by using the evaporation method, the sputtering method or the like, they may be formed by other methods.

Moreover, when an insulating film is formed, a method in which vacuum film formation is performed by sputtering or the like by using an inorganic material such as SiO₂, ZrO₂ or TiO₂, a method in which film formation is chemically performed by the sol-gel method, or the like may be used. When the liquid crystal molecules are aligned, setting may be made by bringing the liquid crystal into contact with the surface of an alignment film formed by a method in which a film of polyimide, polyvinyl alcohol (PVA) or the like is rubbed, a method in which UV light polarized in a specific direction or the like is radiated to a chemical substance having a photoreactive functional group to cause optical alignment, a method in which the film is obtained by oblique evaporation of SiO or the like, a method in which the film is obtained by radiating an ion beam to diamond-like carbon, or the like. The insulating film and the alignment film are convenient because they can prevent short circuit between the transparent electrodes and prevent image sticking of the liquid crystal layer due to energized driving for a long period of time.

Next, speckle contrast Cₛ serving as the index of the speckle noise will be described. This speckle contrast is represented by Expression (1) which is the standard deviation σ of the pixel brightness for Expression (2) which is the average value of the brightness of the pixels as expressed by Expression (3). Here, N is the total number of pixels, Iₙ is the brightness for each pixel, and Iₐᵥᵣ is the average of the brightnesses of all the pixels. The speckle noise observed in the projected image is reduced as the value of the speckle contrast Cₛ becomes a low value. Hereinafter, the projection display device where the liquid crystal scattering element of the invention of the present application is disposed will be evaluated based on this speckle contrast. The speckle contrast is only necessarily not more than 25%, preferably, not more than 20%, and more preferably, not more than 15%.

$$\begin{matrix}[ Expression 1 ] & \\ σ = \sqrt{\frac{{\sum }_{n = 1}^{N} {\vert {I}_{avr} - {I}_{n} \vert}^{2}}{N}} & ( 1 ) \\ [ Expression 2 ] & \\ {I}_{avr} = \frac{{\sum }_{n = 1}^{N} {I}_{n}}{N} & ( 2 ) \\ [ Expression 3 ] & \\ {C}_{s} = \frac{σ}{{I}_{avr}} & ( 3 )\end{matrix}$$

### Second Embodiment

FIG. 5 shows a schematic structure view of a projection display device 30 according to the present embodiment, and of the optical parts and the like constituting the projection display device 30, optical parts and the like the same as those constituting the projection display device 10 are denoted by the same reference numerals to avoid overlapping description. The projection display device 30 is structured such that on the optical path between the laser 11 as the light source and the screen 17 as the object of display, a light scattering element 31 is disposed on the optical path between the polarizer 13 and the liquid crystal scattering element 20 and a light scattering element 32 is disposed on the optical path between the liquid crystal scattering element 20 and the condenser lens 14. Unlike the liquid crystal scattering element 20 the scattering power of which temporally changes, these light scattering elements 31 and 32 have scattering power of a constant level that does not temporally change for the incident light. Moreover, while it may be both of the light scattering elements 31 and 32 that are disposed, it may be either one of the light scattering element 31 and the light scattering element 32 that is disposed or a structure in which they are stacked on the liquid crystal scattering element 20 may be provided.

While as the light scattering elements 31 and 32, for example, a scattering plate the scattering power of which does not temporally change may be used, the present invention is not limited thereto, and any one that homogenerously scatters the incident light may be used; for example, it may be formed of polymer-dispersed liquid crystal or cholesteric liquid crystal. Moreover, as to the scattering angle, based on the definition described in the first embodiment, the upper limit of the scattering angles of the light scattering elements 31 and 32 are preferably not more than the upper limit of the scattering angle of the liquid crystal scattering element, and are preferably not less than 10°. As described above, by using at least one light scattering element (the light scattering element 31 and/or the light scattering element 32) and the liquid crystal scattering element 20 in combination as in the projection display device 30 according to the present embodiment, the speckle noise can be sufficiently reduced in the entire optical system as in the case where the scattering power is reduced only by the liquid crystal scattering element 20. Since the voltage applied to the liquid crystal layer of the light scattering element 20 can be held down thereby, the effect of being able to enhance the reliability of the light scattering element 20 is produced.

### Third Embodiment

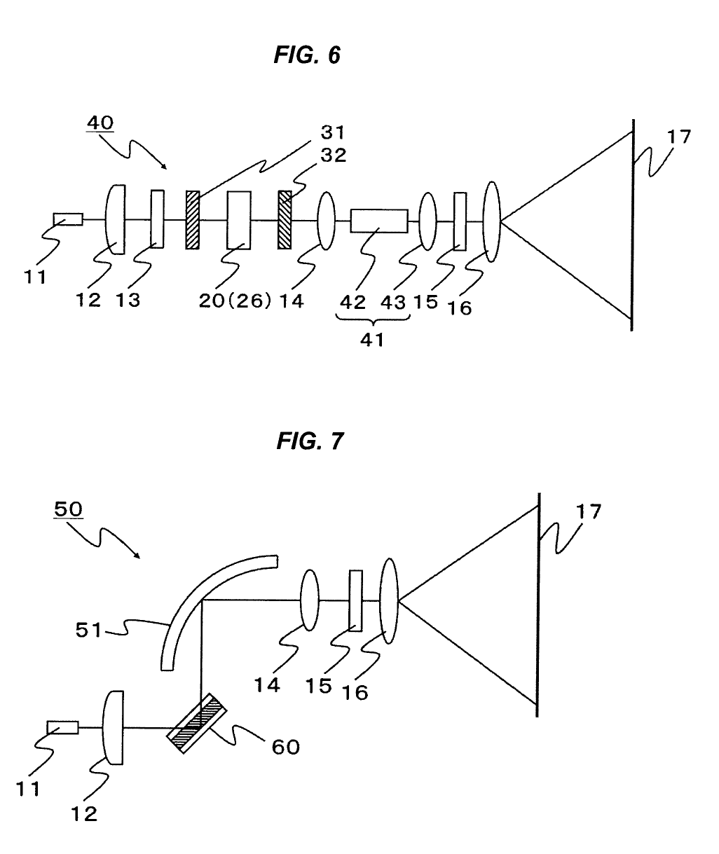

FIG. 6 shows a schematic structure view of a projection display device 40 according to the present embodiment, and of the optical parts and the like constituting the projection display device 40, optical parts and the like the same as those constituting the projection display device 30 are denoted by the same reference numerals to avoid overlapping description. The projection display device 40 has a light amount uniformizing means 41 on the optical path between the condenser lens 14 and the spatial light modulator 15 in order that the light scattered by the liquid crystal scattering element 20 or 26 is radiated in such a way that the light intensity in the region where an image is formed is uniform in the spatial light modulator 15. While the shown projection display device 40 has the light scattering elements 31 and 32, the projection display device 40 may be a device not having these like the projection display device 10 according to the first embodiment.

As the light amount uniformizing means 41, a combination of a rod integrator 42 and a condenser lens 43 is considered. For example, the rod integrator 42 has a glass block in which at least the light exit surface is similar to an image formation surface of the spatial light modulator 15 where an image is formed (hereinafter, referred to as “image formation surface”), and the light incident on this glass block is totally reflected at the side surfaces to be wave-guided and then, exits. Moreover, to reduce the loss of light due to leakage from the side surfaces of the rod integrator 42, a reflection film or a protection film may be formed on the side surfaces. And in order that the light having exited from the rod integrator is imaged on the image formation surface of the spatial light modulator 15, the condenser lens 43 for which a numerical aperture and a focal length are set is disposed. When the scattering angle of the light traveling while being scattered by the liquid crystal scattering element 20 or 26 is narrow, it is unnecessary to dispose the condenser lens 43. That is, in this case, the light having exited from the end portion of the rod integrator 42 may be directly incident on the spatial light modulator 15.

Moreover, as another light amount uniformizing means 41, means may be adopted that is constituted by a combination of a pair of convex lens arrays similar to the image formation surface of the spatial light modulator 15, and a condenser lens. The convex lens arrays are structured in such a way that unit lenses defined as minimum unit lenses are two-dimensionally arranged. At this time, they may be so-called fly eye lenses in which the unit lenses of one convex lens array are arranged so that the light having exited from the unit lenses of the other convex lens array is imaged on the image formation surface of the spatial light modulator 15. In this case, a condenser lens is disposed in the light exit portions of the convex lens arrays so that the shifts of the optical axes of the unit lenses are made to coincide on the image formation surface of the spatial light modulator 15.

Moreover, when the spatial light modulator 15 has polarization dependency, the loss of light used can be suppressed by converting the light incident on the light amount uniformizing means 41 into specific linearly polarized light when it is light not having uniformity of polarization state. As this structure, for example, by disposing, on the optical path between the pair of convex lens arrays, a polarization beam splitter arranged in an array and a space division half-wave plate having a half-wave plate only in a specific region of the light incident region, the incident light can be converted into the specific linearly polarized light and exit. In such a structure, a case where the spatial light modulator 15 is formed of a liquid crystal element having polarization dependency for the incident light or the like is particularly effective since the utilization efficiency of the light can be enhanced.

### Fourth Embodiment

FIG. 7 shows a schematic structure view of a projection display device 50 according to the present embodiment, and of the optical parts and the like constituting the projection display device 50, optical parts and the like the same as those constituting the projection display device 10 are denoted by the same reference numerals to avoid overlapping description. In the projection display device 50, the light scattered and reflected by a liquid crystal scattering element 60 is reflected at a parabolic reflector 51, condensed by the condenser lens 14, incident on the spatial light modulator 15, and projected onto the screen 17 or the like by the projector lens 16. In the projection display device 50, the light scattering elements 31 and 32 shown in the third embodiment may be disposed on the optical path in front of and behind the liquid crystal scattering element 60, or it may be performed to dispose the light amount uniformizing means 41 on the optical path between the parabolic reflector 51 and the spatial light modulator 15 as shown in FIG. 6 and to dispose a combination of the rod integrator 42 and the condenser lens 43 as shown in FIG. 6 as the light amount uniformizing means 41.

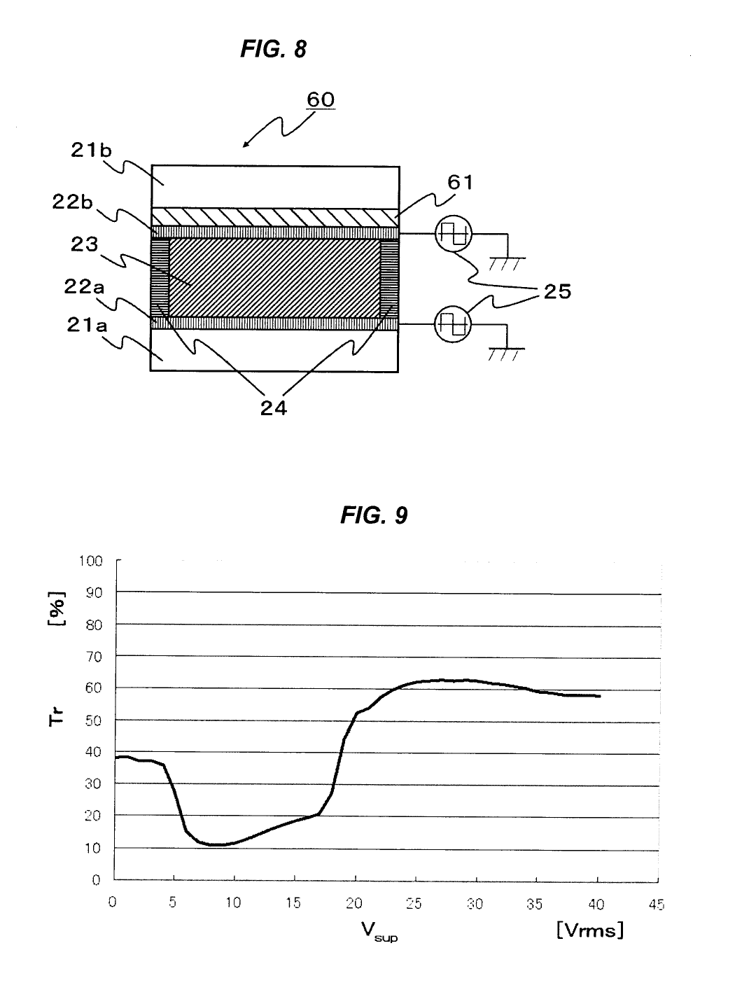

FIG. 8 is a cross-sectional view of the concrete structure of the liquid crystal scattering element 60, optical elements and the like the same as those constituting the liquid crystal scattering element 20 are denoted by the same reference numerals to avoid overlapping description. In the liquid crystal scattering element 60, a reflection layer 61 that reflects light at high reflectance is formed on the side opposite to the light incident side. Moreover, in this case, the liquid crystal scattering element 60 may be an element not having the transparent substrate 21b. The reflection layer may be formed of a film of a metal such as gold or may be formed of an optical multilayer film in which a high refractive index material and a low refractive index material are alternately stacked.

Moreover, in the projection display device 50 of FIG. 7, by placing the liquid crystal scattering element 60 in such a way that light is incident in the order of the liquid crystal layer 23 and the reflection layer 61 and that the incident angle is substantially 45°, for example, the direction of travel can be deflected 90°. As described above, when the liquid crystal scattering element 60 is inclined substantially 45°, it is placed in such a way that the central part (optical axis) of the light traveling while being reflected at the liquid crystal scattering element 60 coincides with the vicinity of the focal position of the parabolic reflector 51. Moreover, for the parabolic reflector 51, compared with general condenser lenses, the angle of capture of the light reflected and scattered by the liquid crystal scattering element 60, that is, the numerical aperture (NA) can be set to be large, so that the utilization efficiency of the light projected toward the screen 17 can be set to be high.

### EXAMPLES

### Example 1

On one surfaces of transparent substrates formed of two pieces of quartz glass with a thickness of approximately 1.1 mm, an ITO film with a sheet resistance value of approximately 100Ω/□ serving as a transparent electrode was formed, and a polyimide film of approximately 50 nm was formed and underwent rubbing processing to form an alignment film having the action of becoming substantially horizontal to the liquid crystal. The alignment film formed surfaces of a pair of transparent substrates were opposed, and the periphery of the transparent substrates was sealed by a sealing member in which spacers were mixed, thereby providing a cell gap of approximately 25 μm. The above-mentioned ITO and insulating film were not provided on the part of the sealing member.

Then, Felix017/100a (AZ Electronic Materials) which was a smectic phase liquid crystal composition was poured from a non-illustrated inlet provided on the sealing member, and the inlet was sealed by a sealing member, thereby producing a liquid crystal scattering element. Moreover, the liquid crystal scattering element had a structure in which an electrode taking part was provided and a voltage could be applied to the sandwiched liquid crystal layer, and could be connected to an external power source from the electrode taking part. The specific resistance value of this ferroelectric liquid crystal composition was 2.6×10¹²Ω·cm, and the spontaneous polarization value was 47 nC/cm² at room temperature (25° C.).

The rectilinear transmittance (Tr [%]) of laser light when the applied voltage (Vₛᵤₚ [Vrms]) was changed by projecting laser light with a wavelength of 633 nm to the produced liquid crystal scattering element was examined. When the value of the voltage applied to the liquid crystal layer with a rectangular AC wave of 100 Hz was increased from 0 Vrms through the transparent electrodes from the external power source, scattering of the incident laser light started at 3 Vrms. FIG. 9 shows a graph of the measured rectilinear transmittance of the laser light with respect to the magnitude of the applied voltage. From this result, it was confirmed that scattering largely occurred at approximately 8 Vrms and that the rectilinear transmittance was approximately 10%. Therefore, by providing the projection display device with this liquid crystal scattering element and causing light scattering state while adjusting the voltage applied to the liquid crystal, projection display can be performed with reduced speckle noise. Moreover, while the applied voltage was increased and the speckle noise reduction effect was confirmed at up to approximately 18 Vrms, when the applied voltage was further increased, the degree of scattering decreased since the ferroelectric liquid crystal became readily aligned in the direction of the electric field; consequently, the rectilinear transmittance increased and speckle noise was observed.

Specifically, the speckle contrast under a condition where a rectangular AC voltage of approximately 8 Vrms and 100 Hz at which scattering state was caused by the liquid crystal scattering element was applied was examined. In the projection display device of FIG. 1, He—Ne laser which was coherent light with a wavelength of approximately 633 nm was emitted as the light source, a diffuser plate of a scattering angle of 10° was disposed in a rectilinear direction of the light having exited from the liquid crystal scattering element, and the image projected on the screen 17 was taken by a digital camera. In the image taking by the digital camera, an image of a square region that was approximately 1.5 cm square in the vicinity of the center of the screen was taken from an angle substantially vertical to the screen surface. At this time, as the condition for the image taking by the digital camera, for the number of pixels of 200×200=40000, the brightness of each pixel was analyzed in 256 steps of 0 to 255, and the speckle contrast was calculated.

The pixel brightness average Iₐᵥᵣ at this time was 104, the standard deviation σ of the pixel brightness was 18, the speckle contrast Cₛ thereby was approximately 17%, and an image could be obtained in which speckle noise was visually inconspicuous.

### Example 2

In Example 2, while a liquid crystal scattering element was produced based on a production method similar to that of Example 1, the rubbing processing performed on polyimide in Example 1 was not performed so that the alignment of the ferroelectric liquid crystal was random at the voltage non-applied state.

Laser light with a wavelength of 633 nm was projected to the produced liquid crystal scattering element, and the rectilinear transmittance of the laser light was examined by voltage application. When the value of the voltage applied to the liquid crystal layer with a rectangular AC wave of 100 Hz through the transparent electrodes from the external power source was increased from 0 Vrms, it was confirmed that scattering largely occurred at approximately 10 Vrms and that the rectilinear transmittance was approximately 1.7%.

By using the above-described element, the speckle contrast under a condition where a rectangular AC voltage of approximately 10 Vrms and 100 Hz at which scattering state was caused by the liquid crystal scattering element was applied was examined. The pixel brightness average Iₐᵥᵣ at this time was 107, the standard deviation σ of the pixel brightness was 16, the speckle contrast Cₛ thereby was approximately 15%, and it was confirmed that the speckle noise could be reduced more effectively than when the initial alignment was regulated by performing rubbing processing on the alignment film.

### Example 3

In Example 3, reliability characteristics against laser were examined by using the liquid crystal scattering element produced in Example 1. Specifically, under a temperature condition of 85° C., laser light of an Ar laser (460 to 520-nm multispectrum) was radiated with an irradiation density of 90 mW/mm² for 280 hours. Thereafter, no significant change occurred on the appearance of the liquid crystal scattering element, and when 10 Vrms of rectangular AC voltage was applied at 100 Hz, it was confirmed that the speckle noise was not more conspicuously observed than before the irradiation and that the liquid crystal scattering element operated without any problem like before the irradiation.

### Example 4

In Example 4, a liquid crystal scattering element was produced the structure of which was similar to that of the liquid crystal scattering element produced in Example 1 except that the cell gap of the liquid crystal layer was approximately 50 μm and that an insulating film of SiO₂ was formed on the ITO film instead of the alignment film, and in which the alignment state of the ferroelectric liquid crystal was random at the voltage non-applied state.

By using the above-described element, the speckle contrast under a condition where a rectangular AC voltage of approximately 30 Vrms and 200 Hz at which scattering state was caused by the liquid crystal scattering element was applied was examined by a measurement method similar to that of Example 1. At this time, a solid-state laser emitting coherent light with a wavelength of approximately 532 nm was caused to emit light as the light source. The pixel brightness average Iₐᵥᵣ at this time was 102, the standard deviation σ of the pixel brightness was 12, the speckle contrast Cₛ thereby was approximately 12%, and it was confirmed that the speckle noise could be sufficiently effectively reduced.

Moreover, the scattering angle of the liquid crystal scattering element produced at this time was 60°, and a scattering angle sufficient for reducing the speckle noise was provided. Moreover, by the present example, it was confirmed that the speckle noise reduction effect was increased by thickening the cell gap of the liquid crystal cell and that the speckle noise reduction effect was similarly obtained even in structures not using an alignment film.

### Example 5

In Example 5, reliability characteristics against laser were examined by using the liquid crystal scattering element produced in Example 4. Specifically, under a temperature condition of 80°, laser light of an Ar laser (460 to 520-nm multispectrum) was radiated from the front side of the element with an irradiation density of 100 mW/mm² for 750 hours. Thereafter, no significant change occurred on the appearance of the liquid crystal scattering element, and when 30 Vrms of rectangular AC voltage was applied at 200 Hz and the speckle contrast Cₛ was measured as in Example 4, the pixel brightness average Iₐᵥᵣ was 95, the standard deviation σ of the pixel brightness was 12, the speckle contrast Cₛ thereby was approximately 13%, and it was confirmed that the speckle noise was not more conspicuously observed than before the irradiation and that the liquid crystal scattering element operated without any problem like before the irradiation. Further, by using the insulating film of SiO₂ which is inorganic, it is expected that reliability and reliability against laser performance further improve.

### Example 6

In Example 6, measurement of utilization efficiency of the light of the liquid crystal scattering element produced in Example 4 was performed. The utilization efficiency of the light was the ratio of the amount of light of the projected image to the amount of light exiting from the liquid crystal scattering element. In Example 6, specifically, He—Ne laser which was coherent light with a wavelength of approximately 633 nm was emitted as the light source under a condition where a rectangular AC voltage of approximately 30 Vrms and 200 Hz was applied to the liquid crystal scattering element produced in Example 4, and a diffuser plate the scattering angle of which was 10°, a rod integrator, a spatial light modulator and a projector lens were disposed in a direction of light exit from the liquid crystal scattering element. The utilization efficiency of the light at this time was approximately 24%. Further, the utilization efficiency of the light when a condenser lens with a numerical aperture of 0.58, was disposed on the optical path between the rod integrator and the spatial light modulator was approximately 29%. This structure corresponds to the arrangement from the liquid crystal scattering element 20 to the projector lens 16 in FIG. 6. Moreover, by increasing the numerical aperture of the condenser lens (corresponding to the condenser lens 43 in FIG. 6), the utilization of the light can be further increased.

### Example 7

In Example 7, a liquid crystal scattering element was produced the structure of which was similar to that of the liquid crystal scattering element produced in Example 4 except that Felix016/000 (AZ Electronic Materials) was used as the smectic phase liquid crystal composition in the liquid crystal layer. The spontaneous polarization of this ferroelectric liquid crystal composition was −4.7 nC/cm² at room temperature (25° C.).

By using the above-described element, the speckle contrast under a condition where a rectangular AC voltage of approximately 30 Vrms and 200 Hz at which scattering state was caused by the liquid crystal scattering element was applied was examined by a measurement method using coherent light with a wavelength of approximately 532 nm as in Example 4. The pixel brightness average Iₐᵥᵣ at this time was 107, the standard deviation σ of the pixel brightness was 17, the speckle contrast Cₛ thereby was approximately 15%, and although the value was high compared with when Felix017/100a was used, it was confirmed that the effect of reducing the speckle noise could be sufficiently delivered.

Likewise, by using the above-described element, the speckle contrast under a condition where a rectangular AC voltage of approximately 40 Vrms and 70 Hz at which larger scattering state was caused by the liquid crystal scattering element was applied was examined. The pixel brightness average Iₐᵥᵣ at this time was 100, the standard deviation σ of the pixel brightness was 14, the speckle contrast Cₛ thereby was approximately 14%, and it was confirmed that the speckle noise could be more effectively reduced.

### Example 8

In Example 8, a liquid crystal scattering element was produced that had two liquid crystal layers in which two liquid crystal scattering elements produced in Example 4 were placed one on another and bonded together by a transparent photo-curable adhesive agent.

By using the above-described element, the speckle contrast under a condition where a rectangular AC voltage of approximately 30 Vrms and 200 Hz at which scattering state was caused by the liquid crystal scattering element was applied was examined without a diffuser plate disposed in the direction of light exit from the liquid crystal scattering element unlike the measurement method similar to that of Example 4. The pixel brightness average Iₐᵥᵣ at this time was 87, the standard deviation σ of the pixel brightness was 8.5, the speckle contrast Cₛ thereby was approximately 10%, and it was confirmed that the speckle noise could be sufficiently effectively reduced even when no diffuser plate was disposed.

### Example 9

In Example 9, the liquid crystal scattering element having two liquid crystal layers produced in Example 8 was used, and the diffuser plate used in Example 1 was disposed on the light exit side of the liquid crystal scattering element. By the same measurement method as that of Example 1 under a condition where a rectangular AC voltage of approximately 60 Vrms and 100 Hz was applied to the liquid crystal layers of the liquid crystal scattering element in such a way as to be in phase, solid-state laser which was coherent light with a wavelength of approximately 532 nm was emitted as the light source, and the speckle contrast was examined. At this time, the pixel brightness average Iₐᵥᵣ was 100, the standard deviation σ of the pixel brightness was 13.0, the speckle contrast Cₛ thereby was approximately 13%, and it was confirmed that the speckle noise could be sufficiently effectively reduced.

### Example 10

In Example 10, the liquid crystal scattering element having two liquid crystal layers which was the same as that of Example 9 was used, and the diffuser plate used in Example 1 was disposed on the light exit side of the liquid crystal scattering element. While a rectangular AC voltage of approximately 60 Vrms and 100 Hz was applied to the liquid crystal layers of the liquid crystal scattering element, by the same measurement method as that of Example 1 under a condition where a phase difference of approximately 90 degrees was provided therebetween, solid-state laser which was coherent light with a wavelength of approximately 532 nm was emitted as the light source, and the speckle contrast was examined. At this time, the pixel brightness average Iₐᵥᵣ was 108, the standard deviation σ of the pixel brightness was 11.9, the speckle contrast Cₛ thereby was approximately 11%, and it was confirmed that the speckle noise could be sufficiently effectively reduced.

### Example 11

In Example 11, with respect to the liquid crystal scattering element produced in Example 4, characteristics with respect to the operating temperature were evaluated. Specifically, under a condition where a rectangular AC voltage of approximately 30 Vrms and 200 Hz was applied to the liquid crystal layer of the liquid crystal scattering element, a solid-state laser emitting coherent light with a wavelength of approximately 532 nm was caused to emit light as the light source, the spackle contrast was examined by the same measurement method as that of Example 1, and the result is shown in Table 1. From Table 1, it was confirmed that the speckle noise could be sufficiently effectively reduced at an operating temperature of 30° C.

TABLE 1

| | | Operating temperature | |
|---|---|---|---|
| Material | Index | 30 [° C.] | 70 [° C.] |
| Felix017/100a | Iₐᵥᵣ | 90 | 91 |
| | Cₛ [%] | 12 | 20 |

### Example 12

In Example 12, a liquid crystal scattering element was produced in which FelixR0424 (AZ Electronic Materials) was used as the smectic phase liquid crystal composition instead of Felix017/100a used for the liquid crystal layer of the liquid crystal scattering element produced in Example 4 and except for that, the structure was the same. FelixR0424 has a phase transition series of Iso-N-SmC*, and has a characteristic of the upper limit temperature region of the smectic C phase being 97.8° C. Then, a solid-state laser emitting coherent light with a wavelength of approximately 532 nm was caused to emit light as the light source under a condition where a rectangular AC voltage of approximately 100 Vrms and 100 Hz was applied to the liquid crystal layer of the produced liquid crystal scattering element, the speckle contrast was examined by the same measurement method as that of Example 1, and the result is shown in Table 2. From Table 2, it was confirmed that the speckle noise could be sufficiently effectively reduced at operating temperatures of 30 to 90° C.

TABLE 2

| | | Operating temperature | | |
|---|---|---|---|---|
| Material | Index | 30 [° C.] | 70 [° C.] | 90 [° C.] |
| FelixR0424 | Iₐᵥᵣ | 96 | 102 | 109 |
| | Cₛ [%] | 11 | 12 | 13 |

### Comparative Example 1

In Comparative Example 1, in a projection display device in which a scattering plate the scattering state of which does not temporally change (stationary type) was disposed instead of a liquid crystal scattering element, an image of a square region that was approximately 1.5 cm square in the vicinity of the center of the screen was taken by a digital camera having similar specifications to those of Example 1. The pixel brightness average Iₐᵥᵣ at this time was 103, the standard deviation σ of the pixel brightness was 30, and the speckle contrast Cₛ thereby was approximately 29% which was approximately twice those of the examples. In addition, conspicuous granular speckle noise was visually observed.

### Comparative Example 2

In Comparative Example 2, the speckle contrast was similarly examined by using a nematic phase liquid crystal composition having negative dielectric anisotropy instead of liquid crystal displaying ferroelectricity. The structure was such that for a liquid crystal element similar to that of Example 2 and in which a nematic liquid crystal composition having negative dielectric anisotropy was poured, the value of the voltage applied to the liquid crystal layer with a rectangular AC wave of 100 Hz through the transparent electrodes from the external power source was increased from 0 Vrms to 40 Vrms. However, no change was seen in the image projected on the screen by the light transmitted by the liquid crystal. Moreover, when the speckle contrast when a rectangular AC voltage of 10 Vrms was applied was examined, the pixel brightness average Iₐᵥᵣ at this time was 105, the standard deviation σ of the pixel brightness was 33, the speckle contrast Cₛ thereby was approximately 31%, and no speckle noise reduction effect was confirmed. The specific resistance value of the nematic liquid crystal composition having negative dielectric anisotropy was 1.9×10¹⁴ Ωcm.

### Comparative Example 3

In Comparative Example 3, as a liquid crystal scattering element using a driving method by the dynamic scanning mode (DSM) method, 0.1 wt % of quaternized ammonium salt was added to a nematic phase liquid crystal composition having negative dielectric anisotropy instead of liquid crystal displaying ferroelectricity, and except for that, the structure was the same as that of Example 1.

As described above, a liquid crystal element using the DSM method and in which a conductive component (quaternized ammonium salt) was added to nematic liquid crystal was produced, and as in Example 3, under a temperature condition of 85° C., laser light of an Ar laser (460 to 520-nm multispectrum) was radiated with an irradiation density of 90 mW/mm², and reliability characteristics against laser were examined. At this time, after 30 hours had elapsed under the above-mentioned condition, a rectangular AC voltage of 14 Vrms and 70 Hz was applied, and it was confirmed that the speckle noise reduction effect was significantly impaired. Because of the addition of the conductive component, the driving by the DSM method required that the specific resistance value of the element be approximately 10⁸ Ωcm to 10¹⁰ Ωcm, and when the specific resistance value at the time of reliability test against the laser was measured, after 30 hours of irradiation, the value became 10¹⁰ Ωcm from 10⁸ Ωcm before the irradiation. The voltage necessary for the development of the DSM also increased because of the increase in the specific resistance value, and it was confirmed that the method using the DSM of the nematic liquid crystal having negative dielectric anisotropy had a problem with the reliability characteristics against laser.

While the present application has been described in detail with reference to specific embodiments, it is obvious to one of ordinary skill in the art that various changes and modifications may be added without departing from the sprit and scope of the present invention. The present application is based on Japanese Patent Application (Patent Application No. 2009-141259) filed on Jun. 12, 2009, Japanese Patent Application (Patent Application No. 2009-257354) filed on Nov. 10, 2009 and Japanese Patent Application (Patent Application No. 2010-062949) filed on Mar. 18, 2010, the contents of which are incorporated herein by reference.

### INDUSTRIAL APPLICABILITY

As described above, an optical head device according to the present invention is capable of providing a projection display device having the effect of being able to reduce the speckle noise with ease and stability when a light source having coherency is used.

### DESCRIPTION OF REFERENCE NUMERALS

10, 30, 40, 50 Projection display device
11 Laser
12 Collimator lens
13 Polarizer
14, 43 Condenser lens
15 Spatial light modulator
16 Projector lens
17 Screen
20, 26, 60 Liquid crystal scattering element
21a, 21b Transparent substrate
22a, 22b Transparent electrode
23 Liquid crystal layer
24 Sealing member
25 Power source
27 Prism array sheet
31, 32 Light scattering element
41 Light amount uniformizing means
42 Rod integrator
51 Parabolic reflector
61 Reflection layer

1. A projection display device comprising:
a light source portion including at least one light source that emits coherent light;
an image light generation portion that generates image light by modulating the light emitted by the light source portion;
a projection portion that projects the image light;
a liquid crystal scattering element that is disposed on an optical path between the light source portion and the image light generation portion and temporally changes scattering state for passing light;
a transparent electrode formed on each of opposing surfaces of a plurality of transparent substrates of the liquid crystal scattering element; and
a liquid crystal layer that is sandwiched between the transparent electrodes and has liquid crystal of a smectic phase having spontaneous polarization in voltage applied state, wherein
an AC voltage is applied to the liquid crystal layer through the transparent electrode.

2. The projection display device according to claim 1, wherein
a condenser lens that condenses scattered light is disposed on the optical path between the liquid crystal scattering element and the image light generation portion.

3. The projection display device according to claim 1, wherein
an alignment processing is not performed on an interface of the liquid crystal layer.

4. The projection display device according to claim 1, wherein
the liquid crystal is chiral smectic C phase liquid crystal.

5. The projection display device according to claim 4, wherein
the liquid crystal has a phase transition series of Iso-N(*)-SmC*.

6. The projection display device according to claim 1, wherein
the liquid crystal scattering element has a structure in which the liquid crystal layer is stacked more than one in number.

7. The projection display device according to claim 6, wherein
a phase of an AC voltage applied to a first liquid crystal layer of the more than one liquid crystal layer and a phase of an AC voltage applied to a second liquid crystal layer of the more than one liquid crystal layer are different from each other.

8. The projection display device according to claim 1, wherein
the liquid crystal scattering element has a prism array sheet.

9. The projection display device according to claim 1, wherein
the liquid crystal scattering element has a reflection layer that reflects incident light.

10. The projection display device according to claim 1, wherein
a voltage where the scattering state occurs is 3 to 100 Vrms.

11. The projection display device according to claim 1, wherein
a frequency of the voltage where the scattering state occurs is 70 to 1000 Hz.

12. The projection display device according to claim 1, wherein
a light scattering element that scatters incident light and emits the light is disposed on the optical path between the light source portion and the liquid crystal scattering element and on the optical path between the liquid crystal scattering element and the image light generation portion.

13. The projection display device according to claim 1, wherein
a light scattering element that scatters incident light and emits the light is disposed on the optical path between the light source portion and the liquid crystal scattering element.

14. The projection display device according to claim 1, wherein
a light scattering element that scatters incident light and emits the light is disposed on the optical path between the liquid crystal scattering element and the image light generation portion.
